(19) United States
(12) Patent Application Publication
(10) Pub. No.: US 2010/0099793 A1
(43) Pub. Date: Apr. 22, 2010

(54) Gluing and Sealing Compounds Having Antimicrobial Properties

(75) Inventor: Thomas WUNDER, Neustadt (DE)

Correspondence Address: O'BRIEN JONES, PLLC, 1951 Kidwell Drive, Suite 550 B, Tyson's Corner, VA, 22182, US

(73) Assignee: Thor GmbH, Speyer (DE)

(21) Appl. No.: 12/521,273

(22) PCT Filed: Dec. 28, 2007
(86) PCT No.: PCT/EP2007/064602

§ 371 Date: Nov. 24, 2009

(30) Foreign Application Priority Data
Dec. 28, 2006 (DE) 10 2006 061 890.4

(51) Int. Cl. C08K 5/34

(52) U.S. Cl. 523/122

(57) ABSTRACT

A description is given of silicone sealants which as a biocidal active comprise 2-n-octyl-4-isothiazolin-3-one and also comprise, where appropriate, one or more other biocides, the biocidal active being included in microparticles comprising an amino resin.

The invention relates to adhesives and sealants, especially silicone rubbers and acrylate sealants, that are antimicrobially furnished with a biocidal active. Said biocidal active is included in a resin based, for example, on an aminoplast. The included biocidal active is suitable as an auxiliary for furnishing adhesives and sealants, such as silicone rubbers or acrylate sealants, for example.

Sealants are elastic materials applied, for example, as flexible profiles or sheets and intended to provide sealing to buildings or installations against water, aggressive media or other atmospheric influences. Sealants include, among others, bitumens, synthetic resin, poly sulfides, acrylates, and silicones.

For adhesive bonding and sealing it is preferred in numerous branches of industry to use silicone rubbers and acrylates, which, however, on the basis of their compositions, may be subject over time to chemical and biological degradation. Depending on the nature of processing and of crosslinking, the silicone rubbers are divided into different types: room-temperature-crosslinking (vulcanizing) rubbers (RTV), liquid silicone rubbers (LSR), and high-temperature-crosslinking (vulcanizing) rubbers (HTV).

The silicone rubbers referred to as RTV-1 silicone rubbers are one-component systems which can be applied directly and which vulcanize to an elastic rubber at room temperature under the influence of atmospheric moisture. In the case of those referred to as RTV-2 silicone rubbers, vulcanization occurs only after the mixing of at least two components. RTV-1 and RTV-2 silicone rubbers are elastic adhesives and sealants.

They are also capable of compensating the different expansion coefficients of different substrates on bonding and/or sealing, and also have a damping action. On the basis of their functional groups they are able to react with other substances in the environment or else with adjuvants in the sealant.

Polymers used for the RTV-1 silicone rubbers are usually linear diorganopolysiloxanes having silanol end groups. In chemical terms they are α,ω-dihydroxyorganopolysiloxanes of the following general formula:

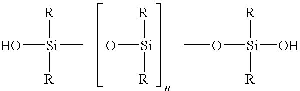

Radicals R used here in practice are usually alkyl radicals, more particularly methyl groups. For specific applications, however, phenyl groups or, for example, trifluoropropyl groups are used as well. The number n can vary within a wide range and is often between 500 and 1500. As is evident from the structural formula, these polymers possess reactive groups at the two ends (—OH groups). Condensation can take place via the silanol group, with elimination of water.

Further adhesives and sealants which have become established in practice are elastic compositions based on acrylate polymers. These are, for example, homopolymers or copolymers of alkyl acrylates (with alkyl groups of 1 to 10 C atoms) with vinyl monomers (such as styrene, acrylonitrile, vinyl butyl ether, acrylic acid, methacrylic acid, or esters of said acids). It is also possible to make use, for example, of polyvinyl compounds (such as divinylbenzene).

From DE-A 101 33 545 it is known to treat sealants with specific fungicidal benzothiophene preparations in order to prevent the polymer compositions going moldy. Reference is made therein to the difficulty of finding suitable fungicides for sealants that are stable and do not suffer leaching. Moreover, the biocides used must be employed at high concentrations, and this can also lead to environmental pollution.

From JP-2002053412 (Daiwa Kagaku Kogyo) it is known to include biocidal actives in a resin matrix. Hence said document describes the inclusion of 2-n-octyl-isothiazolin-3-one (OIT) in a styrene-maleic anhydride resin.

WO 2006/032019 (Mikrotek) describes the encapsulation of biocidal actives such as isothiazolinones (e.g. DCOIT or OIT). A melamine-formaldehyde resin, for example, is presented as enclosure material.

EP-A 0 679 333 (Rohm & Haas) discloses polymers for encapsulation of biocidal actives such as isothiazolinones, for example. These encapsulated actives can be used in paints and varnishes.

U.S. Pat. No. 6,294,589 (Shaw) describes polyurethanes which comprise biocidal actives such as OIT in encapsulated form.

In WO 2004/000953 (Thor) the skilled worker knows coating materials for masonry that comprise a biocidal active such as an isothiazoline in encapsulated form.

The documents cited, however, do not describe any technical solution to providing sealants (with reactive groups) such as silicones with long-lasting protection against microbial infestation.

Many commercial adhesives and sealants contain material which can be degraded microbiologically. Either they are produced in part from microbiologically degradable materials, or they contain degradable components. Adhesives and sealants become particularly prone to microbiological attack when they are provided with formulating agents, such as plasticizers, hydrophobicizers and/or binders, for example, or when they pick up microbiologically degradable material in the course of service, such as organic substances from the environment or residues of soap, for example (in the area of bathrooms, for example).

The infestation of the adhesives and sealants by fungi, algae or bacteria may not only adversely effect the optical qualities but may also negatively impact the service properties of the adhesives and sealants.

Furthermore, the release of metabolic products may give rise to unpleasant odor nuisance and a hazard to health.

It is an object of the present invention to furnish adhesives and sealants with specific biocides (bactericides, fungicides and/or algaecides) in order to prevent or at least minimize infestation by microorganisms, such as fungi, molds, bacteria, including cyano bacteria, yeasts, and algae. This ought to allow long-lasting preservation.

In the furnishing of adhesives and sealants with biocides, however, difficulties occur, relating not only to the finishing operation per se but also to phenomena which result from the furnishing. In the adhesives and sealants industry, exacting demands are imposed on the biocides that are used for furnishing adhesives and sealants. The adhesives and sealants are required to remain stable, for example, even on frequent water contact, and not to be subject to any discoloration, and not to be removable by washing.

There are already effective biocides in existence that are subject only to a low level of degradation and which even when subjected to water remain largely within the adhesives and sealants. Generally speaking, however, the biocides that are satisfactory in this respect have toxic effects which often make them less suitable for the furnishing of adhesives and sealants. Examples here include chlorothalonil and carbendazim, which, however, have considerable activity loopholes and/or ensure effective fungicidal protection only at very high concentrations.

The active substance that remains on the adhesives and sealants after they have been furnished with it is washed off in the course of practical use in contact with moisture, as for instance on contact with falling water (e.g. under the shower). As a result of this, but also as a result of the formulation and storage of the adhesives and sealants, a considerable loss of active is recorded. Furthermore, the influence of light in the region of window seals may also lead to decomposition of the biocidal actives that have remained after the furnishing process. When this process is complete, there are also instances—as a result of the interaction of certain heavy metal ions with biocides, such as zinc pyrithione, for example—of unwanted discoloration of the adhesives and sealants observed. Inhibition of vulcanization may also occur.

As a result of the loss of actives it is frequently necessary to use expensive actives having high minimum inhibitory concentration (MIC) values at a high concentration in order to obtain, in spite of the water-contact losses of active, the desired antimicrobial activity that satisfies the practical requirements, and this entails considerable costs. Moreover, the high use concentrations and the high losses of biocidal active are a burden on the environment.

The invention is also based, therefore, on the object of providing antimicrobially furnished adhesives and sealants, especially silicone rubbers, which largely avoid the disadvantages set out above. For instance, the environmental burden and the costs of the furnishing of the adhesives and sealants for controlling harmful microorganisms are to be lowered, and the leaching of the biocidal active from the furnished adhesives and sealants is to be reduced. The antimicrobial action of the biocide used ought to remain ensured for a long period of time. A further object is to provide alternatives to toxicologically objectionable compositions.

This object is achieved through the provision of a sealant which is furnished with at least one specific biocidal active. The biocidal active used is preferably 2-n-octyl-4-isothiazolin-3-one (OIT), which per se is already known as a biocide and has the following formula:

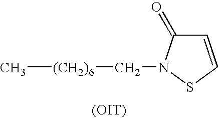

Alternatively (or else additionally) to OIT it is also possible as biocidal active to use 4,5-dichloro-2-n-octyl-4-isothiazolin-3-one (DC-OIT) and/or N-alkyl-1,2-benzisothiazolin-3-one, it being possible with OIT to achieve a surprisingly long-lasting preservation.

Furthermore, one or more further biocides are employed where appropriate in the sealant. The biocidal active, more particularly OIT, may preferably be included in microparticles, in particular in an amino resin, more preferably in a melamine-formaldehyde resin.

It is also possible in principle, however, to use other “inclusion agents” or capsule material as well for the OIT, the DC-OIT and/or the N-alkyl-1,2-benzisothiazolin-3-one. The active or actives are preferably included in an amino resin.

The term “biocidal active” in the context of the present invention identifies the substance or composition which has the biocidal effect on which the invention is based. The biocidal active component in each case comprises 2-n-octyl-4-isothiazolin-3-one or one of the two abovementioned alternative actives; where appropriate, further actives may be present.

The present invention provides quite generally a sealant which is furnished with a biocidal active and which as its biocidal active comprises OIT (or one of the abovementioned alternatives) and also, where appropriate, one or more further biocides, the 2-n-octyl-4-isothiazolin-3-one used with preference being included in microparticles comprising an inclusion agent, more particularly an amino resin.

Sealants of particular interest are RTV-1 or RTV-2 silicone rubber and acrylate sealants, the best results being achieved in the case of sealants comprising RTV-1 or RTV-2 silicone rubber.

The adhesives and sealants, especially the RTV-1 or RTV-2 silicone rubbers or the acrylate sealants, comprise the microparticles used preferably in amounts of 0.01% to 5% by weight, based on the total weight of the amino resin.

The invention also relates to a sealant, which is an RTV-1 or RTV-2 silicone rubber or an acrylate sealant, which as microparticles comprises 25% to 45% by weight of an amino resin and 55% to 75% by weight of the biocidal active, based on the total weight of the amino resin and of the biocidal active.

In a further embodiment of the invention the sealant is characterized in that the amount of the biocidal active, based on the total weight of the sealant, is 0.0001% by weight to 0.5% by weight.

In one embodiment of the invention the sealant is characterized in that the amount of the biocidal active, based on the total weight of the sealant, is 0.01% by weight to 0.2% by weight.

In a further embodiment of the invention the sealant is characterized in that the amino resin is selected from the group consisting of melamine-, urea-, cyano- and dicyanodiamide-formaldehyde resins or a mixture of two or more of these resins. An amino resin is preferably a melamine-urea-formaldehyde resin or a melamine-phenol-formaldehyde resin, more particularly a melamine-formaldehyde resin.

In a further embodiment of the invention the sealant is characterized in that the amino resin is formed from a compound containing NH groups and from acetaldehyde or glyoxal.

In a further embodiment of the invention the sealant is characterized in that the microparticles comprising the biocidal active have an average diameter of 0.5 to 100 μm. The D-50 value is preferably 1 to 15 μm; the D-90 value is preferably less than 60 μm.

In one particular embodiment of the invention the sealant is characterized in that, in addition to the microparticles comprising a biocidal active OIT, it comprises a further biocidal component, which may be encapsulated or nonencapsulated. A particularly suitable further biocidal component is OIT in nonencapsulated form.

The invention also provides, furthermore, a process for preparing a sealant furnished with a biocidal active, which involves admixing a sealant during preparation with the microparticles comprising 2-n-octyl-4-isothiazolin-3-one (and/or the alternative actives). This addition may be made, for example, by mixing of the components at the premises of the producer, or else not until directly in the course of use.

In a further embodiment of the invention the process for producing a sealant furnished with a biocidal active is characterized in that the sealant is an RTV-1 or RTV-2 silicone rubber or is an acrylate sealant, and the microparticles comprising OIT as biocide are admixed during preparation in an amount, based on the total weight of the sealant, of 0.01% by weight to 0.2% by weight.

The present invention also provides for the use of OIT (or the alternatives) and, where appropriate, of microparticles comprising one or more further biocides and based, for example, on an amino resin to protect sealants from infestation by microorganisms, particularly against fungal infestation. In particular the microparticles are added to an RTV-1 and RTV-2 silicone rubber or to an acrylate sealant in the course of the preparation.

In one embodiment of the present invention the microparticles comprise, as biocidal active, 2-n-octyl-4-isothiazolin-3-one and also, additionally, one or more other biocides. In that case the ratio of 2-n-octyl-4-isothiazolin-3-one to the other biocide or biocides may in principle fluctuate and be varied within wide limits, as for example in the range from 100:1 to 1:100, preferably 50:1 to 1:50, more particularly 1:25 to 25:1. In accordance with one embodiment of the invention the 2-n-octyl-4-isothiazolin-3-one is present customarily in amounts of 10% to 95% by weight, more particularly of 20% to 80% by weight, and the other biocide or biocides are present in amounts of 5% to 90% by weight, more particularly of 20% to 80% by weight, based in each case on the total amount of biocidal active present.

In a further embodiment the biocidal active included in the microparticles is composed predominantly of 2-n-octyl-4-isothiazolin-3-one. This means that the included biocidal active comprises as its major constituent 2-n-octyl-4-isothiazolin-3-one, preferably in an amount of greater than or equal to 50% by weight of 2-n-octyl-4-isothiazolin-3-one, more preferably in an amount of greater than or equal to 70% by weight, more particularly in an amount of greater than or equal to 90% by weight, more particularly in an amount of greater than or equal to 95% by weight of 2-n-octyl-4-isothiazolin-3-one, based on the total mass of biocidal active. In addition it is possible for at least one further biocide to be present (from the group of the isothiazolinones, for example).

In a further embodiment of the invention the biocidal active included in the microparticles is composed substantially of 2-n-octyl-4-isothiazolin-3-one; in other words, besides 2-n-octyl-4-isothiazolin-3-one, there may also be one or more other biocides present, but only in an amount such that there is no contribution of the respective biocide (different from 2-n-octyl-4-isothiazolin-3-one) to the overall effect of the resultant mixture. If the biocidal activity of a biocidal active (biocide mixture) which besides 2-n-octyl-4-isothiazolin-3-one also has one or more further biocides as an essential constituent, in a subordinate or minor concentration, is unchanged relative to the use of 2-n-octyl-4-isothiazolin-3-one alone, as the sole biocide, this is referred to in the context of the present invention as “substantially composed”.

In a further embodiment the biocidal active may be composed of 2-n-octyl-4-isothiazolin-3-one as the sole biocidal active, i.e., an active content of 100% of 2-n-octyl-4-isothiazolin-3-one. In such a case it is possible for there to be one or more further constituents present without a biocidal effect.

For the purposes of the invention the term “silicone rubber” relates in particular to the above-described RTV-1 and RTV-2 silicone rubbers. The use of a biocide in LSR and HTV rubbers or in other sealants is likewise possible, however.

Polymers used for the RTV-1 silicone rubbers are frequently linear diorganopolysiloxanes having silanol end groups, of the following formula:

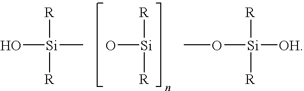

Organic radicals R used are the groups referred to above. The number for n can vary within a wide range and is preferably between 500 and 1500, in particular between 600 and 1500.

Suitable crosslinkers for RTV-1 silicone rubber are, in particular, polyfunctional organosilicon compounds which are able at room temperature to react with OH groups, such as the silanol groups of the polymers or the OH group of water, for example. Polyfunctional means that per crosslinker molecule there are at least three reactive groups present. The crosslinkers here have the general formula Si X₄ or R Si X₃, for example. The radical R may be, for example, an alkyl or aryl radical, it being possible via the radical R to influence the solubility, reactivity, boiling and/or melting point of the crosslinker and also, indirectly, the properties of the rubber produced using it. The chemical nature of the radicals X may vary greatly.

There is a whole spectrum of hydrolysis-sensitive reactive silanes that can be used as crosslinkers in RTV-1 silicone rubber systems. According to the chemical nature of the crosslinker cleavage products, the various crosslinkers can be divided into acidic, alkaline, and neutral systems. In the case of acidic crosslinkers the radical X in the crosslinker is an acetoxy group, for example. This is a well-established crosslinking system. The cleavage product in this case is acetic acid. A further acidic system that may be mentioned is the acetate system. In the course of the vulcanization, 2-ethylhexanoic acid is eliminated, which on account of its low vapor pressure is a relatively low-odor compound, on the one hand, but on the other hand remains in the vulcanizate for a long time.

In the case of the basic crosslinkers, amino groups in particular function as radical X. It is usual to use primary amino groups of the structure NHR₁, with groups such as n-butyl, sec-butyl or cyclohexyl being used for R₁.

There is a whole series of neutral systems for crosslinkers which have proven problematic in practice, such as, for example:
the oxime system, in which the radical X is composed of aldoximo or ketoximo groups;
the alcohol system. Alkoxy groups function as radical X in this case, and may be, for example, methoxy, ethoxy and/or methylglycoxy groups;
the acid amide system, in which X symbolizes an acid amide group.

The crosslinker fulfills essentially three chemical functions and must not be incompatible with the other components (e.g., the biocide):
a) the blocking of the silano end groups of the dimethylpolysiloxane to form a product which is stable on storage in the absence of moisture;
b) the reaction with the OH groups that are present in the system, in the form, for example, of water, or with silanol groups of the fillers;
c) the maintenance of the crosslinking reaction.

The excess of crosslinker that is normally used and that is not bound by the OH groups serves to impart storage stability to the overall system of the adhesives and sealants and to play a mediator role as a relatively mobile molecule in the polymer matrix on crosslinking. The crosslinker ought to be compatible with the biocide.

In accordance with the invention an RTV-1 silicone rubber may be composed only of polymer, crosslinker, and biocide. In that case, however, the silicone rubber formed on vulcanization has a very low mechanical strength. This strength can be improved decisively by addition of—for example—fillers.

In the case of the fillers a distinction is made between reinforcing fillers and inert fillers, with intermediate forms being possible as well. Reinforcing fillers used are primarily fumed silicas, i.e., amorphous silicas produced by flame hydrolysis, which, on account of their chemical relatedness to the silicones, are particularly suitable for these systems. Not only the mechanical properties but also the rheological properties can be directed through the use of fumed silica. In the case of inert fillers, true chemical or physical interactions with the polymers or crosslinkers occur only to a minor extent, if at all. In practice, for example, calcium carbonates, aluminum silicates, finely ground quartzes, diatomaceous earth or iron oxides are used.

Plasticizers used in the RTV-1 silicone rubbers of the invention are, for example, dialkylpolysiloxanes blocked with trimethylsilyl end groups, of the following structure:

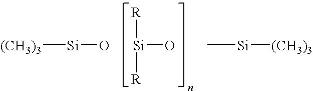

where n and R can have the definitions stated above.

These silicone oils possess the same chemical parent structure as the polymers, and hence are fully compatible and enter into physical interaction with the polymer and in some cases with filler. Their function is to reduce the hardness. In some cases the elongation at break and tear propagation resistance of the sealant are increased as well.

Catalysts frequently employed in practice are, for example, organometallic compounds of tin and of titanium. They can have a great variety of chemical structures. Dibutyltin acetate is cited as a typical example. The catalysts have the function of ensuring a balanced ratio between the rate of hydrolysis and the condensation of the silanol groups, in other words the crosslinking proper.

Specific properties of RTV-1 silicone rubbers can be achieved through the use of additives. For instance, the adhesion of RTV-1 silicone rubbers can be improved considerably through addition of adhesion promoters. These are, for example, alkoxyl-functional silanes of the structure Z—Si (OR)₃, where Z may be, for example, aminopropyl, glycidyloxypropyl or mercaptopropyl groups and the alkoxy groups are usually lower alcohol groups such as methoxy or ethoxy moieties ensuring a chemical bond to the polysiloxane binder.

By means of additives such as pigments, heat stabilizers, flame retardants, and stabilizers it is possible to achieve specific properties on the part of the sealants of the invention. All of the additives employed ought to be compatible with the 2-n-octyl-4-isothiazolin-3-one.

On account of differences in their chemical construction, the RTV-2-silicone rubbers that are likewise of the invention are divided into two groups:
a) condensation-crosslinking RTV-2 silicone rubber, and
b) addition-crosslinking RTV-2 silicone rubber.

In the same way as for the RTV-1 silicone rubber, the base polymer in the condensation-crosslinking RTV-2 silicone rubber is an α,ω-OH-terminal dialkylpolysiloxane, the molecular weights usually being somewhat lower than in the case of RTV-1 silicone rubber. Examples to of crosslinkers used are silicic esters, which may be monomeric or incipiently condensed, of the general formula Si(OR)₄, for example, where R represents lower alkyl groups such as ethyl or propyl groups. Generally speaking, the larger the radical R, the slower the crosslinking. In order to obtain a significant rate for the reaction of the silicic esters with the OH groups of the dialkylpolysiloxane, catalysts are used, usually organotin compounds such as dibutyltin dilaurate, for example. In some cases reaction products of silicic esters and organotin compounds as well are used as curing agents.

It is important that the sealants contain catalytic amounts of water, so that vulcanization throughout the sample proceeds at a uniform rate irrespective of the layer thickness. The vulcanization releases alcohol. It is important that the alcohol is volatilized from the rubber as completely as possible before the rubber is subjected to any thermal load. If the vulcanizate still contains alcohol and is loaded with temperatures above 90° C., the crosslinking reaction reverses and the silicone rubber undergoes softening. As further constituents the condensation-crosslinking RTV-2 rubber necessarily comprises a biocide (which may be added at different points in time and in different ways) and also, where appropriate, fillers, plasticizers, and additives.

The addition-crosslinking RTV-2 silicone rubber exploits the feature whereby Si-bonded hydrogen can be added to unsaturated carbons. The base polymer is generally composed of an α,ω-vinyl-terminated dialkylpolysiloxane.

The crosslinker used is a methylhydropolysiloxane of the general formula

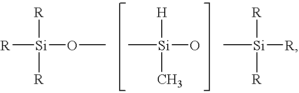

which also, if required, may contain dimethylsiloxane groups in the chain.

The reaction of the Si—H group with the Si-vinyl groups is catalyzed by noble metal catalysts, such as by platinum complexes, for example. The reaction rate can be controlled via the amount of catalyst and/or by addition of inhibitors. As in the case of the condensation-crosslinking RTV systems, the addition-crosslinking RTV-2 silicone rubbers of the invention also comprise a biocidal component and, where appropriate, fillers, plasticizers, and additives. Since the production of addition-crosslinking RTV-2 silicone rubber is a true addition reaction, there are no cleavage products given off during the vulcanization. A feature of the addition-crosslinking RTV-2 silicone rubber is a high temperature dependence of the vulcanization behavior. With a temperature increase there is a drastic acceleration in the addition reaction, and so compositions which require a day to vulcanize at room temperature vulcanize within just a few minutes at temperatures of 150° C.

The RTV-1 silicone rubbers of the invention are ready-to-apply one-component compositions of fluid or flexible-pastelike consistency which may already contain the biocide or which else have it added to them at application. Under the influence of atmospheric humidity, they react to form an elastic rubber. The higher the relative atmospheric humidity, the greater the rate of vulcanization. First, at the surface of the compositions, a skin is formed, after which the vulcanization process goes down into the composition as the water molecules diffuse. The rate of vulcanization at 50% relative atmospheric humidity, depending on the system, is for example about 1 to 2 mm per day.

For extensive adhesive bonds on substrates which are impervious to air, therefore, RTV-1 silicone rubber is not very suitable, and for such applications the RTV-2 silicone rubbers of the invention are appropriate. RTV-2 silicone rubbers are two-component systems.

The composition, which may be fluid or pastelike, is admixed with a curing component (and, where appropriate, the biocide component) and mixed intensively by hand, with a stirrer or in fully automatic metering and mixing devices. The curing agents are usually liquids, but may also consist of pastes.

With the condensation-crosslinking systems the addition of curing agent amounts generally to about 2 to 4 percent by weight. Depending on the amount and reactivity of the curing agent, the processing time is about 20 to 60 minutes and the time to vulcanization is 1 to 24 hours.

With the addition-crosslinking systems, the ratio of the two components is usually 9:1, the mechanical properties of the vulcanizate being modified by variation of the mixing ratio. Depending on the construction of the crosslinker and the amount of catalyst and inhibitor, the processing time is from a few minutes to several hours, and, accordingly, vulcanization times are from a few minutes to several days at room temperature. The rate of vulcanization can be increased by raising the temperature. The biocidally furnished addition-crosslinking RTV silicone rubbers are very flexible systems.

The mechanical properties of the vulcanized RTV-silicone rubbers are heavily dependent on their structure. One of the most outstanding properties of RTV-silicone rubbers is their excellent temperature resistance. On the basis of their chemical construction from a network and Si—O links, the majority of types retain their elasticity at temperatures up to 180° C. If a higher temperature loading is required, then it is also possible to use heat-stabilized types which withstand even temperatures of 250° C. for a long time (see also HTV silicones). In the low-temperature range, RTV silicone rubbers remain elastic down to about −50° C., while special types remain elastic even down to −110° C. Vulcanizates of biocidally furnished RTV silicone rubber possess outstanding weathering stability and ageing resistance, and in particular do not molder.

Experiences have been gained (particularly in the field of exterior grouting) which show that RTV silicone rubbers are highly durable sealants. Even after long outdoor weathering, no changes have occurred in the surface or in the physical properties of the sealants of the invention. Corresponding long-term laboratory trials under stringent conditions have likewise shown excellent stability behavior.

The resistance of vulcanizates made of RTV silicone rubber of the invention toward weak acids or bases and also toward polar solvents and salt solutions is generally very good. In solvents such as ketones, ethers, aliphatic, aromatic, and chlorinated hydrocarbons, there is more or less severe swelling of the silicone rubber. This swelling, however, is reversible; i.e., following evaporation of the solvents, the vulcanizate again possesses its original form and strength. Whether it is possible to use silicone rubber in permanent or temporary contact with these solvents is dependent on factors including the mechanical and chemical exposure, the area of exposure, and the duration. RTV fluorosilicone rubbers which have been biocidally furnished exhibit virtually no swelling even on exposure to these solvents.

At room temperature the electrical properties of the RTV silicone rubbers of the invention show good comparison with those of other insulating materials. It is important, however, that there is virtually no change in insulation resistance, breakdown strength, and dielectric loss factor even at higher temperatures. On water storage as well there is hardly any change in the electrical properties. On combustion, the RTV silicone rubbers leave behind a scaffold of SiO₂, which, as a nonconductor, increases safety. This can also be used to explain the excellent leakage current resistance of the silicones of the invention.

Whereas the RTV-1 silicone rubbers display very good adhesion to many substrates, the adhesion of RTV-2 silicone rubbers is generally poor without priming. If the adhesiveness of RTV-1 silicone rubbers is considered in accordance with the crosslinking system, the general rule is that the amine systems possess very good adhesion. They are followed closely by acetic systems, whereas the oxime systems, and especially the alcohol systems, exhibit substantially poorer adhesion. By adding internal adhesion promoters it is possible for considerable shifts in this rule to occur.

Also known are condensation-crosslinking RTV-2 systems which comprise special adhesion promoters in the product, and which possess excellent adhesion to a very wide variety of substrates.

With the addition-crosslinking RTV-2 silicone rubbers as well, remarkable adhesions, particularly when vulcanization is carried out at a relatively high temperature, have been achieved by addition of adhesion promoters which are compatible with the biocidal active. Should the adhesion not be sufficient, it is possible in many cases to improve it by the use of a primer. Generally speaking, solutions of functional silanes and silicone resins are employed. An adhesive bond of those plastics which are considered to be problem plastics, such as PTFE, PE or PP, with the RTV silicone rubbers of the invention is possible in principle.

Amino resins for the purposes of the present invention are polycondensation products of carbonyl compounds, particularly of formaldehyde and compounds containing NH groups, such as, for example, urea (urea resins), melamine (melamine resins), urethanes (urethane resins), cyanamide and dicyanamide (cyanamide resins and dicyanamide resins), aromatic amines (aniline resins), and sulfonamides (sulfonamide resins): in this regard see Römpps Chemie Lexikon, Thieme Verlag Stuttgart, 9th, expanded edition, 1995, page 159. Preferred materials of the microparticles are melamine-, urea- and dicyandiamide-formaldehyde resins; particularly preferred materials are melamine-formaldehyde resins.

The abovementioned urea resins are curable condensation products of ureas and aldehydes that belong to the class of the amino resins, and in particular they comprise formaldehyde. They are prepared by reacting urea or substituted ureas with formaldehyde in a molar excess under usually alkaline conditions. The products are oligomers which contain hydroxymethyl groups and which are cured with crosslinking. In lieu of formaldehyde it is also possible to use other aldehydes—acetaldehyde or glyoxal, for example. Condensates based on modified ureas are also starting materials that can be used in the context of the invention in the production of the microparticle material.

Melamine resins are amino resins in which melamine, under suitable conditions, has undergone polycondensation with carbonyl compounds such as aldehydes and ketones, such as formaldehyde, acetaldehyde or glyoxal, for example. They are prepared generally by reacting melamine with the carbonyl compound in a molar excess.

Of particular interest in this context are the polycondensation products of melamine with formaldehyde (melamine-formaldehyde resins) or else melamine-formaldehyde resins modified with urea and/or phenol (melamine-urea-formaldehyde resins, melamine-phenol-formaldehyde resins). These resins and their preparation are known to the skilled worker.

The microparticles which comprise the included biocidal active may also be formed from two or more of the aforementioned amino resins. In selecting the microparticle material, particular care should be taken to ensure that in the course of production there is no destruction or inhibition of the biocidal active.

As a result of the inclusion of the biocidal active in the microparticles, it is volatilized or released only to a very small extent, or not at all, in the course of the production of the silicone rubbers and their application. Furthermore, the silicone rubber remains biocidally active, since the active remains in the rubber, and so it can be used at correspondingly low concentrations. In practical use, the biocidal active is released slowly. In this context it has been found, advantageously, that in the course of contact with falling water (or with water) of the silicone rubbers furnished with the biocidal active included in the microparticles, said active is not washed out to a high degree.

In this way it is possible in accordance with the invention on the one hand to use smaller quantities of active for the furnishing operation, and on the other hand to obtain considerably longer periods of action.

In accordance with the present invention, the term “microparticle” refers to any kind of particles which comprise a wall structure and at least one cavity formed by the wall structure. The wall structure in this case comprises one or more amino resins, but preferably one. The cavities formed by the wall structure may be closed or else open in form, and contain the biocidal active and, where appropriate, further different auxiliaries. Closed cavities may be present, for example, in the form of capsule structures or cell structures, while open cavities may be present in the form of pores, channels, and the like.

For the purposes of the invention, the term “microparticles” may likewise signify a matrix of an amino resin, with the biocidal active being included in the matrix and/or enveloped by it. The term “microparticle” may also be applied to so-called microcapsules, in whose interior the biocidal active is included in encapsulated form.

The microparticles preferably have a spherical shape. This shape has the advantage of a high volume on low surface area, and so impinging water has a small area to wet.

The average diameter (D-50 value) of the microparticles that can be used for the furnishing of sealants is typically in the range from about 0.5 to about 40 μm; the preferred average diameter is in the range from about 1 to about 15 μm. The size of the microparticles can be determined, for example, under the microscope using a micrometer scale.

The furnishing of the sealants with biocide is carried out such that the antimicrobially furnished rubber generally comprises an amount of biocidal active, based on the total weight of the rubber, of 0.0001% by weight to 0.5% by weight, preferably of 0.0.1% by weight to 0.2% by weight, more preferably of 0.05% by weight to 0.15% by weight.

Since there is always only a low concentration of the biocidal active on the surface of the microparticles and hence on the surface of the sealants, the product properties of the sealants, such as their hydrophobicity or oleophobicity, for example, are not negatively impacted.

Furthermore, as a result of the slow release of the biocidal active, a long-term effect can be achieved even with relatively low use concentrations.

This carries both environmental and economical advantages, since during the processing of the sealants only a small proportion of the biocidal active is lost, and, as a result, it can be used in substantially smaller quantities.

The inclusion of the biocidal active in the microparticles not only has the advantage of retarded release of the biocidal active; instead, the shielding of the biocidal active by the particle wall means that it has an enhanced stability with respect to UV radiation, heightened temperatures, heavy metal ions, and pH levels. Thus, for example, the duration of action of the biocidal active, as a result of a lower decomposition rate, is prolonged considerably. There are also no instances of discoloration. No defects are observed on vulcanization. Surprisingly, the compositions furnished with the microparticles are transparent. There is no negative interaction of the resin surrounding the active with the silicone or acrylate compositions. The stability of the formulations is high.

Often utilized are combinations of different 3-isothiazolin-3-ones or else of one or more 3-isothiazolin-3-ones with other known biocidal actives (see, for example, WO 99/08530, EP-A 0457435, EP-A 0542721, and WO 02/17716). With regard to the constantly increasing requirements imposed on such biocide compositions, in respect for example of health and environmental-protection aspects, further development of the known products is necessary for the antimicrobial furnishing of sealants.

Biocidal actives enclosed in a melamine-formaldehyde resin and intended for application in coating materials, especially in renders for facades, are known from EP-A 1 519 995. That document, however, provides no indication that 2-n-octyl-4-isothiazolin-3-one included in an amino resin, preferably in a melamine-formaldehyde resin, is outstandingly suitable for the furnishing of sealants such as silicone rubbers. Particularly surprising in this context is the fact that only slight escape of the biocidal active from the microparticles is observed, but, after the sealant has been produced, the particles provide retarded release of the biocidal active in the desired degree.

The inclusion of the biocidal active in the microparticles based on the amino resin largely prevents its being released.

2-n-Octyl-4-isothiazolin-3-one (OIT) has antimicrobial properties which are desirable per se for the furnishing of adhesives and sealants. These include the fungicidal, bactericidal, and algaecidal effects, which add together to give an active-substance profile which is advantageous for the application identified above.

On account of the broad spectrum of action of 2-n-octyl-4-isothiazolin-3-one, the use of the microparticles of the invention is particularly suitable for the furnishing of silicone rubbers which are used in the outdoor segment, since 2-n-octyl-4-isothiazolin-3-one is a biocide having fungicidal, bactericidal, and algaecidal activity. It contains neither halogen compounds nor heavy metals compounds, it is not persistent or accumulable, it is not classed as a CMR substance, and it possesses a favorable human-toxicity and ecotoxicity profile.

In terms of its properties, therefore, it is generally very well suited to the furnishing of adhesives and sealants. Hence its use is advantageous not only from an environmental and economic standpoint but also on the basis of its advantageous activity spectrum.

For inclusion in the microparticles it is additionally possible, as well as 2-n-octyl-4-isothiazolin-3-one, to use one or more other biocides as well, which may be selected as a function of the field of use. Specific examples of such additional biocides are given below:

benzyl alcohol; 2,4-dichlorobenzyl alcohol; 2-phenoxyethanol; 2-phenoxyethanol hemi-formal, phenylethyl alcohol; 5-bromo-5-nitro-1,3-dioxane: bronopol; formaldehyde and formaldehyde depot substances; dimethyloldimethylhydantoin; glyoxal; glutardialdehyde; sorbic acid; benzoic acid; salicylic acid; p-hydroxybenzoic esters; chloroacetamide; N-methyl-lolchloroacetamide; phenols, such as p-chloro-m-cresol and o-phenylphenol; N-methylolurea; N,N′-dimethylolurea; benzyl formal; 4,4-dimethyl-1,3-oxazolidine; 1,3,5-hexahydrotriazine derivatives; quaternary ammonium compounds, such as N-alkyl-N,N-dimethyl-benzylammonium chloride and di-n-decyldimethylammonium chloride; cetylpyridinium chloride; diguanidine: polybiguanide; chlorhexidine; 1,2-dibromo-2,4-dicyanobutane; 3,5-dichloro-4-hydroxybenzaldehyde: ethylene glycol hemiformal; tetra(hydroxy-methyl)phosphonium salts; dichlorophen;
2,2-dibromo-3-nitrilopropionamide; 3-iodo-2-propynyl N-butylcarbamate; methyl N-benzimidazol-2-ylcarbamate; 2,2′-dithiodibenzoic acid di-N-methylamide; 2-thiocyano-methylthiobenzothiazole; C-formals such as 2-hydroxymethyl-2-nitro-1,3-propanediol and 2-bromo-2-nitropropane-1,3-diol; methylenebisthiocyanate; reaction products of allantoin; 2-methylisothiazolin-3-one; N-alkyl-1,2-benzisothiazolin-3-ones having 1 to 8 C atoms in the alkyl radical; N-methyl-1,2-benzisothiazolin-3-one; N-butyl-1,2-benzisothiazolin-3-one; 4,5-dichloro-2-n-octylisothiazolin-3-one; 4,5-trimethylene-2-methylisothiazolin-3-one; 1,2-benzisothiazolin-3-one (BIT); zinc pyrithione: chlorothalonin; propioconazole; tebuconazole; TCMTB; IPBC, terbutryn, cyfluthrin, isoproturon, and triclosan.

Examples of a formaldehyde depot substance are N-formals, such as tetramethylolacetylenediurea; N,N′-dimethylolurea; N-methylolurea; dimethylol-dimethylhydantoin; N-methylolchloroacetamide; reaction products of allantoin: glycol formals, such as ethylene glycol formal: butyl diglycol formal: benzyl formal.

Preferred biocidal actives in accordance with the invention are 2-n-octyl-4-isothiazolin-3-one alone, DC-OIT alone, N-alkyl-1,2-benzisothiazolin-3-one alone, or one of these three actives in combination with one or more biocides from the group consisting of BIT, N-butyl-BIT, N-methyl-BIT, IPBC, tebuconazole, DC-OIT, terbutryn, cyfluthrin, isoproturon, triclosan, silver, compounds of silver, and zinc pyrithione.

In accordance with one particular embodiment of the invention, 2-n-octyl-4-isothiazolin-3-one is used as the sole biocidal active, the active being present either completely in microparticles or else in encapsulated form and in unencapsulated form (for example, 50% by weight OIT encapsulated +50% by weight OIT unencapsulated).

Where further biocides as well are used in the microparticles of the invention as a biocidal active besides 2-n-octyl-4-isothiazolin-3-one, this further biocide may be present together with the 2-n-octyl-4-isothiazolin-3-one as a mixture in the microparticles.

It is, however, also possible for microparticles which contain only 2-n-octyl-4-isothiazolin-3-one to be mixed with microparticles which contain only the further biocide, and for this mixture of microparticles to be introduced into the silicone rubber.

In addition, the microparticles comprising the biocidal active may also comprise other adjuvants which are commonplace and customary for the application and are known to the skilled person. Examples of these are thickeners, defoamers, pH modifiers, fragrances, dispersing assistants, and colorants or discoloration preventatives, complexing agents, and stabilizers such as, for example, UV stabilizers.

In accordance with the invention the microparticles that are used for furnishing silicone rubbers or acrylate sealants preferably comprise no solvents that are harmful to health. The solvent used with preference for their production is water, but it must generally be removed prior to use.

Where, in accordance with one particular embodiment of the invention, further solvents are employed when producing the microparticles, these solvents may be polar or a polar or may be mixtures comprising polar and a polar solvents.

Besides water further polar fluid solvents include the following: aliphatic alcohols having 1 to 4 carbon atoms, e.g., ethanol and isopropanol, a glycol. e.g., ethylene glycol, diethylene glycol, 1,2-propylene glycol, dipropylene glycol, and tripropylene glycol, a glycol ether. e.g. butyl glycol and butyl diglycol, a glycol ester, e.g., butyl diglycol acetate or 2,2,4-trimethyl-pentanediol monoisobutyrate, a polyethylene glycol, a polypropylene glycol, N,N-dimethyl-formamide or a mixture of two or more such solvents. When a polar solvent is used, the polar liquid solvent ought preferably to be removed before the microparticles are used. As a polar liquid solvents it is possible with preference for OH-free solvents to be employed, examples being aromatics, preferably xylene and toluene.

These as well may be used alone or as a mixture of two or more such solvents. The microparticles may also be employed in powder form.

In accordance with a further embodiment of the invention a chemical anchoring of the microparticles of the invention to the surface of the silicone rubber is implemented.

Since the surface of the microparticles has reactive groups, such as amino, hydroxyl, and methylol groups (CH₂—OH), it is possible for it to be anchored durably to the silicone rubber with the aid of a suitable reactive binder, an isocyanate for example, more particularly a protected or blocked isocyanate. Through the suitable choice of the monomer ratio when preparing the amino resin, such as of the ratio of formaldehyde to melamine in the melamine-formaldehyde resins, for example, it is possible to influence the nature and number of the reactive groups. For example, an excess of melamine increases the prevalence of amino groups.

The invention further provides for the use of microparticles that comprise the active 2-n-octyl-4-isothiazolin-3-one and, where appropriate, one or more other biocides and are based on an amino resin to protect adhesives and sealants from infestation by microorganisms.

It has emerged as being particularly effective, in the case of one embodiment of the invention, if the biocidal active comprises 2-n-octyl-4-isothiazolin-3-one. The advantage of this biocidal active also lies in the fact that 2-n-octyl-4-isothiazolin-3-one effectively prevents the infestation of the silicone rubber by algae, bacteria, and fungi.

In the microparticles of the invention the biocidal active is included preferably in a finely disperse, liquid or solid phase; with particular preference, the biocidal active is introduced in an aqueous medium in the production of the microparticles.

There are numerous known methods of producing these microparticles; in this regard see, for example, C. A. Finch, R. Bodmeier. Microencapsulation, Ullmann's Encyclopedia of Industrial Chemistry, 6th edition 2001, Vol 21 Electronic Release, pages 733 to 749. The appropriate method in each case can be selected as a function of the desired wall thickness. The stated pages of the literature citation are incorporated by reference in the present specification.

The production of the melamine-formaldehyde microparticles used with preference encompasses the use of melamine-formaldehyde precondensates which are water-soluble and from which melamine-formaldehyde resin microparticles are produced from aqueous phase.

The production method has a variety of advantages, such as, for example, in addition to starting materials that are inexpensive in comparison to other possible polymerization processes, the environmentally benign use of water as a preferred solvent. If the biocidal actives included or encapsulated are not readily water-soluble, a possible alternative is the partial substitution of the water solvent used in the operation by organic solvents that are miscible with water.

The starting point in the production of the microparticles of the invention is preferably an aqueous suspension of the biocidal active or mixture of actives, using water as a solvent. The microparticles of the invention are produced preferably with stirring in an acidic medium. The acidic medium is established using organic and/or inorganic acids such as, for example, hydrochloric acid, phosphoric acid, and citric acid.

The microparticles can be produced in the apparatus that are customary for condensation polymerizations. These include stirred tanks, stirred tank cascades, autoclaves, tube reactors, and kneading apparatus. The reaction is carried out for example in stirred tanks which are equipped with an anchor stirrer, paddle stirrer, impeller stirrer, dissolver stirrer or multistage pulsed countercurrent stirrer. Particularly suitable are apparatus which permit the direct isolation of the product following polymerization, such as paddle dryers, for example. The suspensions obtained can be dried directly in evaporators, such as, for example, belt dryers, paddle dryers, spray dryers or fluid-bed dryers. An alternative is to separate off the majority of the water by filtering or centrifuging.

One starting material used for the melamine-formaldehyde resins that are employed with preference comprises obtainable etherified melamine-formaldehyde condensates having preferably a low free formaldehyde content, such as, for example Quecodur DM 70 (available from THOR GmbH). The melamine-formaldehyde resin can also be prepared by polycondensation of melamine and formaldehyde in the presence of the biocidal active, by techniques known to the skilled worker, such as by reaction between melamine and formaldehyde at a molar ratio of 1 to 6 parts of formaldehyde per part of melamine.

The reaction is carried out preferably in aqueous solution. Depending on the wall thickness and on the desired amount of biocidal active in the completed microparticles, the concentration of the prepolymer in the aqueous solution may be varied over a wide range. The most advantageous is to supply and/or form the prepolymer in such a way that the prepolymer concentration is about 1% to 70% by weight, preferably about 5% to about 50% by weight.

In addition to the aforementioned amino resins, the microparticles of the invention may comprise further substances which, depending on the intended use, are common knowledge and customary. These include, on the one hand, corresponding binders and film formers, such as polyacrylates, polystyrene acrylates or silicone resins, and, on the other hand, known auxiliaries, such as pigments; fillers such as calcium carbonate, talc, kaolins, silicates, fumed silica and/or zeolites; solvents; thickeners such as polysaccharide and/or cellulose ethers: defoamers; plasticizers; dispersants such as phosphates and/or acrylates; emulsifiers such as fatty alcohol ethoxylates, EO/PO block polymers and/or sulfonates; stabilizers such as UV stabilizers, and colorants or discoloration preventatives.

The polycondensation of the amino resin may be carried out at any desired point within the range from about 20 to about 95° C., preferably between about 50 and 80° C. The reaction will generally be at an end within a few hours, although the reaction may be at an end within a few minutes at a high temperature.

As soon as the microparticles have formed they can be stored as dispersions and used, or recovered in filtered form as dried particles. The microparticles comprising the biocidal active can also be added to the silicone rubber in the course of its preparation.

The silicone rubbers in accordance with the present invention can be used for example, in the following segments:

a) in the construction and glass industries, for example, for
expansion joints in construction and civil engineering
connection joints for windows, doors, and metal windowsills
window sealing between glass and frames of wood, plastic or metal
interior fitment in the sanitary sector, sealing of bath tubs, wash basins, shower cabinets, bonding of mirrors
bonding of insulating glazing (construction of modern insulating glazing, with RTV silicone rubber as an external sealant)
structural glazing
a new architecture through the bonding of glass elements with RTV silicone rubber
aquarium construction
   b) in automotive, air travel and mechanical engineering, for example, for
bonding of rear window spoilers, mudguards, mirrors, trim strips, badges
   c) in the electrical and electronics industry, for example, for
household appliances:
   bonding of Ceran plates, hinges and metal parts in front windows of ovens
   bonding of HTV profile beads to ovens
   bonding of handles to glass jugs
headlights and lamp bonding
bonding and coating of electronic components
bonding of solar cells.

Further applications are also found in medical engineering, the textile industry, the rubber industry, and laboratory equipment. The examples which follow illustrate the sealants of the present invention.

### EXAMPLE 1

### Production of Microparticles

Described below is the production of microparticles in which the biocidal active OIT is included.

1a) Using the substances below, microparticles based on melamine-formaldehyde were produced in which the biocidal active 2-n-octyl-4-isothiazolin-3-one is included.

| Substances used | Amounts [g] |
|---|---|
| water | 430.00 |
| polyacrylate | 1.50 |
| (Coatex BR 3, manufacturer: Dimed) | |
| gum arabic | 0.60 |
| silicone defoamer | 0.30 |
| (Aspumit AP, manufacturer: Thor GmbH) | |
| 2-n-octyl-4-isothiazolin-3-one | 60.00 |
| hydrochloric acid (1% strength) | 46.10 |
| melamine-formaldehyde resin | 85.00 |
| (Quecodur DM 70, manufacturer: Thor GmbH) | |
| | 623.50 |

For the production of the microparticles the water and the melamine-formaldehyde resin were charged to a glass vessel. Then polyacrylate, gum arabic, silicone defoamer, and the 2-n-octyl-4-isothiazolin-3-one were introduced with stirring. The resulting mixture was heated to 90° C. and hydrochloric acid was added dropwise for 1 hour to a pH of 4. Subsequently the mixture was stirred at the same temperature for 2 hours. The mixture present contained the desired microparticles, in which the biocidal active is included. The product can be separated off (e.g., filtered) and dried. It can also be employed as a powder.

1b) Using the substances below, microparticles with OIT were produced:

| Substances used | Amounts [g] |
|---|---|
| water | 530.00 |
| polyacrylate (Coatex BR 3) | 1.50 |
| gum arabic | 0.60 |
| silicone defoamer (Aspumit AP) | 0.30 |
| OIT | 40.00 |
| hydrochloric acid (1% strength) | 46.10 |
| melamine-formaldehyde resin (Quecodur DM 70) | 90.00 |
| | 708.50 |

For the production of the microparticles the water and the melamine-formaldehyde resin were charged to a glass vessel. Then, with vigorous stirring, polyacrylate, gum arabic, silicone defoamer, and the OIT were introduced. The resulting mixture was heated to 90° C. and stirred further for an hour with thorough mixing, and with dropwise addition of hydrochloric acid to a pH of 4. Subsequently the mixture was stirred at the same temperature for 2 hours. The mixture present contained the desired microparticles, in which OIT is included.

### EXAMPLE 2

### Use of OIT_{encapsulated} in Sealants

The microbiological tests were carried out each in duplicate determinations along the lines of the standard EN ISO 846 B. For this purpose the sealants themselves were applied to inert support material (e.g., glass plates) approximately 2 mm thick, and, after curing, were cut into sections measuring 3×3 cm.

These sections, described below as test specimens, were subjected, both without water storage and after 2 days of water storage in fully demineralized water, with a change of water at 24 hours, to the ISO 846 test, part B. In this test, the test specimens were placed on carbon-containing nutrient media (complete agar) for monitoring of the fungicidal action, and were then sprayed with a mixture of fungal spores; 0.1 ml of suspension per test specimen.

The spore suspension contained 10⁶ CFU/ml and comprised the following fungi:

| | |
|---|---|
| Aspergillus niger | ATCC 6275 |
| Alternaria alternata | DSM 12633 |
| Penicillium funiculosum | CMI 114933 |
| Paecilomyces variotii | ATCC 18502 |
| Gliocladium virens | ATCC 9645 |
| Chaetomium globosum | ATCC 6205. |

The samples thus inoculated were incubated at 25° C. for 28 days. This was followed by a visual evaluation of the sample surface. Where no growth was evident with the naked eye, the test took place with the assistance of a microscope. The ISO 846 tests were evaluated using the following scheme:
0 No growth evident when viewed with a microscope.
1 Slight growth, no growth evident to the naked eye, readily apparent microscopically.
2 Slight growth, readily apparent macroscopically, growth over not more than 25% of the sample surface.
3 Moderate growth, growth over up to 50% of the sample surface.
4 Severe growth, growth over more than 50% of the sample surface, but not over the entire area.
5 Severe growth over the entire sample surface.

Encapsulated OIT, obtained according to the preparation example, is referred to below as OIT encapsulated. It was either incorporated into the respective sealant by a producer of sealants, or added to the sealant prior to the test.

### EXAMPLE 2.1

### Neutral-Crosslinking Silicone, Methoxy Basis

Three vulcanizates neutrally crosslinking, on a methoxy basis, were used, of which sample 1 contains OIT in encapsulated form, sample 2 contains carbendazim and sample 3 contains no active (cf. Tables 1 and 2).

Both without water storage (0d) and after 2 days of water storage (2d), sample 1 shows a good fungicidal activity with respect to mold colonization. The unfurnished control, blank, shows severe fungal growth (0d and 2d). The carbendazim-containing reference shows moderate fungal growth both with (2d) and without (0d) water storage.

TABLE 1
Results of tests to ISO 846 part B in duplicate
determinations (column a and b, respectively)

| | | Fungal growth after 28 d | |
|---|---|---|---|
| | | Method B | |
| Specimen | Water | Complete agar | |
| Silicone, methoxy basis | storage | a | b |
| 1. with fungicidal treatment | 0 d | 0 | 0 |
| 1. with fungicidal treatment | 2 d | 0 | 0 |
| 2. with fungicidal treatment | 0 d | 2 | 1 |
| 2. with fungicidal treatment | 2 d | 4 | 3 |
| 3. without fungicide | 0 d | 5 | 5 |
| 3. without fungicide | 2 d | 5 | 5 |

TABLE 2
Results of analysis for active on the tested vulcanizates Ex.
2.1 (0 d (without water storage) and 2 d (after water storage)

| | | Analysis for active | |
|---|---|---|---|
| Sample designation | Exposure/ | Active [ppm] | |
| Silicone, methoxy basis | water storage | OIT | Carbendazim |
| 1. with fungicidal treatment | 0 d | 1130 | n.d. |
| 1. with fungicidal treatment | 2 d | 1110 | n.d. |
| 2. with fungicidal treatment | 0 d | n.d. | 760 |
| 2. with fungicidal treatment | 2 d | n.d. | 720 |
| 3. without fungicide | 0 d | n.d. | n.d. |
| 3. without fungicide | 2 d | n.d. | n.d. |

### EXAMPLE 2.2

### Neutral-Crosslinking Silicone, Oxime Basis

The blank sample, without active, exhibited a high susceptibility to fungal colonization even without water storage, 0d. By adding 500 ppm of OIT encapsulated it was possible to achieve a complete fungicidal effect. Test specimens tested in parallel with unencapsulated OIT showed a similar action to those containing encapsulated OIT, with the same amount used, without water storage (0d), but after water storage (2d) they showed moderately severe growth. Additionally, the samples furnished with 1000 ppm of OIT encapsulated were analyzed. Even after water storage of these test specimens, almost 80% of the active employed was recovered.

TABLE 3
Results according to ISO 846 part B

| | | Fungal growth after 28 d | |
|---|---|---|---|
| | | Method B | |
| Sample designation | Exposure/ | Complete agar | |
| Silicone, oxime basis | water storage | a | b |
| Blank | 0 d | 3 | 3 |
| Blank | 2 d | 4 | 4 |
| 500 ppm OIT encapsulated | 0 d | 0 | 0 |
| 500 ppm OIT encapsulated | 2 d | 0 | 0 |
| 1000 ppm OIT encapsulated | 0 d | 0 | 0 |
| 1000 ppm OIT encapsulated | 2 d | 0 | 0 |
| 500 ppm OIT | 0 d | 0 | 1 |
| 500 ppm OIT | 2 d | 3 | 3 |
| 1000 ppm OIT | 0 d | 0 | 0 |
| 1000 ppm OIT | 2 d | 3 | 2 |

TABLE 4
Results of analysis for active before
(0 d) and after (2 d) water storage

| Sample designation | Exposure/ | Active [ppm] |
|---|---|---|
| Silicone, oxime basis | water storage | Oit |
| 1000 ppm OIT encapsulated | 0 d | 880 |
| 1000 ppm OIT encapsulated | 2 d | 790 |
| 1000 ppm OIT | 0 d | 740 |
| 1000 ppm OIT | 2 d | 230 |

### EXAMPLE 2.3

### Testing of Sealants with Acrylate System

Acrylate sealants with increasing concentrations of OIT encapsulated were tested. In line with the increasing OIT concentration there was a boosting of the fungicidal effect. Above an amount of 650 ppm of OIT, a sufficient fungicidal effect was achieved even after water storage (2d).

The unfurnished sample, in contrast, showed severe colonization.

TABLE 5
Results of the microbiological tests to ISO 846 part B

| | | Fungal growth after 28 d | |
|---|---|---|---|
| | | Method B | |
| Samples | Water | Complete agar | |
| Acrylate | storage | a | b |
| A blank | 0 d | 5 | 5 |
| A blank | 2 d | 5 | 5 |
| B 163 ppm OIT encapsulated | 0 d | 4 | 4 |
| B 163 ppm OIT encapsulated | 2 d | 4 | 4 |
| C 325 ppm OIT encapsulated | 0 d | 3 | 3 |
| C 325 ppm OIT encapsulated | 2 d | 4 | 4 |
| D 650 ppm OIT encapsulated | 0 d | 2 | 2 |
| D 650 ppm OIT encapsulated | 2 d | 2 | 2 |
| E 975 ppm OIT encapsulated | 0 d | 1 | 1 |
| E 975 ppm OIT encapsulated | 2 d | 0 | 0 |

The examples listed clearly show the advantages of the encapsulated OIT in acrylate systems (Ex. 2.3) and silicone systems (Ex. 2.1 and. 2.2). On the one hand, there is a distinct increase in activity relative to the conventional standard biocide carbendazim; on the other hand, encapsulated OIT is notable for a greatly improved retention. The long-term effect of the encapsulated OIT was tested in comparison to carbendazim and unencapsulated OIT in a neutral-crosslinking system (acetoxy basis). For that purpose the samples were tested for their fungicidal effect without water storage (0d) and after a period of 3 months during which once a week there was 24 hour storage in fully demineralized water. This was done in accordance with ISO 846 part B, according to the details outlined above.

### EXAMPLE 2.4

### Testing of a Neutral-Crosslinking System, Acetoxy Basis

The blank samples (without water storage) showed severe fungal colonization even without water storage (0d). Furnished with carbendazim, with 1000 ppm of active, slight colonization was apparent without water storage (0d), while, after the 3-month water storage cycle (3 months), the samples furnished both with 500 and with 1000 ppm of carbendazim showed severe fungal growth.

The encapsulated OIT versions showed no growth or minimal growth without water storage (0d), and even after the exposure phase (3 months) the test specimens with 1000 ppm of OIT encapsulated were free from fungal growth. The formulations with free OIT that were tested in parallel, in contrast, showed a good action without water storage (0d), but after the 3-month water storage cycles were heavily overgrown.

TABLE 6
Results of long-term effect according to ISO 846 part B

| | | Fungal growth after 28 d | |
|---|---|---|---|
| | | Method B | |
| Sample designation | Water | Complete agar | |
| Silicone, acetoxy basis | storage | a | b |
| blank | 0 d | 4 | 5 |
| blank | 3 months | 5 | 5 |
| 500 ppm OIT encapsulated | 0 d | 1 | 0 |
| 500 ppm OIT encapsulated | 3 months | 2 | 3 |
| 1000 ppm OIT encapsulated | 0 d | 0 | 0 |
| 1000 ppm OIT encapsulated | 3 months | 1 | 0 |
| 500 ppm OIT | 0 d | 1 | 2 |
| 500 ppm OIT | 3 months | 5 | 5 |
| 1000 ppm OIT | 0 d | 0 | 0 |
| 1000 ppm OIT | 3 months | 4 | 5 |
| 500 ppm carbendazim | 0 d | 3 | 4 |
| 500 ppm carbendazim | 3 months | 5 | 5 |
| 1000 ppm carbendazim | 0 d | 2 | 2 |
| 1000 ppm carbendazim | 3 months | 4 | 5 |

### EXAMPLE 2.5

### Testing of a Neutral-Crosslinking Silicone System on Ace Oxy Basis with OIT Encapsulated (Protected) and OIT Unencapsulated (Free)

400 ppm of OIT were introduced in each case into an acetoxy system, in the following composition:

a) 400 ppm of OIT free (F) (in the form of OTW 8)
b) 400 ppm of OIT protected (P) (in the form of OTA 8)
c) 400 ppm of OIT (F) OIT (P) proportionally, 50% in each case

These sealants were analyzed for the amounts of OIT present, both without water storage and after 2 days of water storage, and the leaching (%) was calculated. The results are at out in Table 7.

Clear differences are apparent between free and protected OIT. Even in the mixture containing OIT encapsulated and OIT unencapsulated, reduced leaching can be seen. Growth experiments were performed on these three preparations as well.

TABLE 7

| | Amount of active (ppm) | | |
|---|---|---|---|
| | Without | With | |
| | water | water | % |
| Addition of OIT | storage | storage | leaching |
| 400 ppm free OIT (F) | 420 | 265 | 37 |
| 400 ppm protected OIT (P) | 430 | 390 | 9 |
| Combination 400 ppm OIT (P) + (F) | 410 | 325 | 21 |

1. An adhesive or sealant furnished with a biocidal active, comprising microparticles containing
25% to 45% by weight of an amino resin based on the total weight of the amino resin and of the biocidal active;
55% to 75% by weight of the biocidal active, based on the total weight of the amino resin and of the biocidal active; the biocidal active being selected from the group consisting of 2-n-octyl-4-isothiazolin-3-one, 4,5-dichloro-2-n-octyl-4-isothiazolin-3-one, N-alkyl-1,2-benzisothiazolin-3-one, and mixtures thereof; and
optionally one or more further biocidal components.

2. The adhesive or sealant of claim 1, characterized in that the adhesive and sealant is an RTV-1 or RTV-2 silicone rubber or is an acrylate sealant.

3. The adhesive or sealant of claim 1, characterized in that it is an RTV-1 or RTV-2 silicone rubber and the the biocidal active is 2-n octyl-4 isothiazolin 3-one.

4. The adhesive or sealant of claim 1, characterized in that the adhesive or sealant is a neutral-crosslinking silicone rubber.

5. The adhesive or sealant of claim 1, characterized in that the amount of the biocidal active 2-n-octyl-4-isothiazolin-3-one, based on the total weight of the sealant, is 0.0001% by weight to 0.5% by weight.

6. The adhesive or sealant of claim 1, characterized in that the amount of the biocidal active 2-n-octyl-4-isothiazolin-3-one, based on the total weight of the adhesive or sealant, is 0.01% by weight to 0.2% by weight.

7. The adhesive or sealant of claim 1, characterized in that the amino resin is selected from the group consisting of melamine-, urea-, cyano- and dicyandiamide formaldehyde resins or a mixture of two or more of these resins.

8. The adhesive or sealant of claim 1, characterized in that the amino resin is a melamine-urea-formaldehyde resin or a melamine-phenol-formaldehyde resin.

9. The adhesive or sealant of claim 1, characterized in that the microparticles comprise the biocidal active 2-n-octyl-4-isothiazolin-3-one and a melamine-formaldehyde resin.

10. The adhesive or sealant of claim 1, characterized in that the amino resin is formed from a compound containing NH groups and from acetaldehyde or glyoxal.

11. The adhesive or sealant of claim 1, characterized in that the microparticles comprising the biocidal active 2-n-octyl-4-isothiazolin-3-one and a melamine formaldehyde resin have a diameter of 0.5 to 100 μm.

12. The adhesive or sealant of claim 1, characterized in that in addition to the 2-n-octyl-4-isothiazolin-3-one and microparticles comprising a melamine formaldehyde resin it comprises a further biocidal component.

13. The adhesive or sealant claim 1, characterized in that in addition to the 2-n-octyl-4-isothiazolin-3-one and microparticles comprising a melamine-formaldehyde resin it comprises OIT in nonencapsulated form as a further biocidal component.

14. The adhesive or sealant of claim 1, characterized in that in addition to the 2-n-octyl-4-isothiazolin-3-one and microparticles comprising a melamine-formaldehyde resin the adhesive or sealant comprises as a further biocidal component at least one of the following actives: benzyl alcohol; 2,4-dichlorobenzyl alcohol; 2-phenoxyethanol; 2-phenoxyethanol hemiformal, phenylethyl alcohol; 5-bromo-5-nitro-1,3-dioxane; bronopol; formaldehyde and formaldehyde depot substances; dimethyloldimethylhydantoin; glyoxal; glutardialdehyde; sorbic acid; benzoic acid; salicylic acid; p-hydroxybenzoic esters: chloroacetamide; N-methylolchloroacetamide; phenols; N-methylolurea; N,N′-dimethylolurea; benzyl formal; 4,4-dimethyl-1,3-oxazolidine; 1,3,5-hexahydrotriazine derivatives; quaternary ammonium compounds; cetylpyridinium chloride; diguanidine; polybiguanide; chlorhexidine; 1,2-dibromo-2,4-dicyanobutane; 3,5-dichloro-4-hydroxybenzaldehyde; ethylene glycol hemiformal; tetra(hydroxymethyl)phosphonium salts; dichlorophen; 2,2-dibromo-3-nitrilopropionamide; 3-iodo-2-propynyl N-butylcarbamate; methyl N-benzimidazol-2-ylcarbamate; 2,2′-dithiodibenzoic acid di-N-methylamide; 2-thiocyano-methylthiobenzothiazole; C-formals; methylenebisthiocyanate: reaction products of allantoin; 2-methylisothiazolin-3-one; N-alkyl-1,2-benzisothiazolin-3-ones having 1 to 8 C atoms in the alkyl radical; N-methyl-1,2-benzisothiazolin-3-one; N-butyl-1,2-benzisothiazolin-3-one; 4,5-dichloro-2-n-octyl isothiazolin-3-one; 4,5-trimethylene-2-methylisothiazolin-3-one: 1,2-benzisothiazolin-3-one (BIT); zinc pyrithione; chlorothalonin; propioconazole; tebuconazole; TCMTB; IPBC, terbutryn, cyfluthrin, isoproturon, and triclosan.

15. A process for preparing an adhesive or sealant furnished with a biocidal active, comprising the step of admixing an adhesive or sealant preparation with microparticles comprising 2-n-octyl-4-isothiazolin-3-one and a melamine formaldehyde resin.

16. The process for preparing an adhesive or sealant furnished with a biocidal active of claim 15, characterized in that the adhesive or sealant is an RTV-1 or RTV-2 silicone rubber or is an acrylate sealant, and the 2-n-octyl-4-isothiazolin-3-one is used in an amount, based on the total weight of the adhesive or sealant of 0.01% by weight to 0.2% by weight.

17. The process for preparing an adhesive or sealant furnished with a biocidal active of claim 15, characterized in that the adhesive or sealant is an RTV-1 or RTV-2 silicone rubber, and 2-n-octyl-4-isothiazolin-3-one in microparticles is used as a biocidal active, in an amount, based on the total weight of the adhesive or sealant, of 0.01% by weight to 0.2% by weight.

18. A method of protecting an adhesive or sealant from infestation by microorganism comprising the step of adding microparticles comprising 2-n-octyl-4 isothiazolin-3-one and an amino resin to to an adhesive or sealant composition.

19. A method of use of claim 18, characterized in that the microparticles are added to an RTV-1 and RTV-2 silicone rubber or to an acrylate sealant in the course of the preparation.
